(19) United States
(12) Patent Application Publication
(10) Pub. No.: US 2006/0002527 A1
(43) Pub. Date: Jan. 5, 2006

(54) Network telephone system and telephone terminal

(76) Inventors: Toshiaki Takahashi, Tokyo (JP); Yoshishiro Uto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/168,870

(22) Filed: Jun. 29, 2005

(30) Foreign Application Priority Data
Jun. 30, 2004 (JP) 2004-194934

(51) Int. Cl. H04M 11/00

(52) U.S. Cl. 379/93.09

(57) ABSTRACT

When, for instance, a telephone conversation is carried on by way of an IP telephone terminal, a control section of the IP telephone terminal adjusts, through control of a comfort amplifier, the level of comfort noise so as to superimpose the comfort noise on a received voice signal in accordance with a private branch to which a telephone terminal on the other party of the telephone conversation is connected.

### RELATED APPLICATIONS

The present disclosure relates to the subject matter contained in Japanese Patent Application No. 2004-194934 filed on Jun. 30, 2004, which is incorporated herein by reference in its entirety.

### BACKGROUND OF The INVENTION

1. Field of the Invention

The present invention relates to a network telephone system that connects a telephone terminal to a network such as a LAN (local area network) for transmitting voice packets. The present invention also relates to a telephone terminal for use in the network telephone system.

2. Description of the Related Art

In recent years, there has been put forward a system that connects, to a LAN, network telephone terminals [IP (internet protocol) telephone terminals] having a telephone processing function and a media information processing function, and which connects the LAN to an external communication network such as a public switched network by way of a gateway. The IP telephone terminals and the gateway perform protocol conversion, conversion of a data format, and the like, thereby enabling communication between the IP telephone terminals and between the IP telephone terminal and the external communication network.

Meanwhile, in a system of the above-described type, delayed reflection of a signal (hereinafter simply called an “echo”) is added to a voice signal when the IP telephone terminal is connected to an analogue central office line or to a private line. To this end, addition of an echo canceling function for canceling an echo added to a voice signal to a gateway has been discussed (see, e.g., U.S. Pat. No. 6,404,887B1).

### SUMMARY OF The INVENTION

Meanwhile, when the IP telephone terminal and the central office line are connected, the echo canceling function works effectively. However, in a case where the IP telephone terminals, which are less susceptible to the influence of an echo, are connected to each other (peer-to-peer), the echo canceling function becomes unstable rather than operating effectively.

Alternatively, there has also been proposed a method wherein comfort noise is superimposed on a received voice signal in an IP telephone terminal, thereby masking the noise produced in a received voice signal. However, even when this method is employed, in a case where the IP telephone terminals, which are less susceptible to the influence of an echo and involve low noise, are connected to each other, instability is created.

The present invention provides a network telephone system that can favorably maintain a quality of a received voice signal in a telephone terminal even when different communication lines are connected, as well as when an echo canceller is connected. The present invention also provides a telephone terminal for use in the network telephone system.

According to a first aspect of the invention, there is provided a network telephone system including: a telephone terminal and a gateway. The telephone terminal is connected to a first communication line for transmitting voice packets, converts the voice packets received through the first communication line into a voice signal, converts input voice signal into voice packets, and transmits the converted voice packets through the first communication line. The gateway is connected to the first communication line and to a second communication line for transmitting the voice signal, and selectively establishes connection between telephone terminals connected to the first communication line and between the telephone terminal and a terminal connected to the second communication terminal in accordance with a request for establishing the connection. The gateway includes a notification unit that notifies to the telephone terminal of line identification information that identifies to which of the first and the second communication line the other end of the telephone terminal or the terminal which the connection is established is connected. The telephone terminal includes: a compensation unit that compensates quality of a received voice signal with an arbitrary level of compensation; and a controller that controls the level of compensation performed by the compensation unit in accordance with the line identification information notified by the notification unit.

According to a second aspect of the invention, there is provided a telephone terminal that is connected to a first communication line for transmitting voice packets, converts the voice packets received through the first communication line into a voice signal, converts input voice signal into voice packets, and transmits the converted voice packets through the first communication line. The telephone terminal includes: a compensation unit that compensates quality of a received voice signal with an arbitrary level of compensation; and a controller that controls the level of compensation performed by the compensation unit in accordance with line identification information notified by a gateway that is connected to the first communication line and to a second communication line for transmitting the voice signal, the gateway selectively establishing connection between telephone terminals connected to the first communication line and between the telephone terminal and a terminal connected to the second communication terminal in accordance with a request for establishing the connection, the line identification information identifying to which of the first and the second communication line the other end of the telephone terminal or the terminal which the connection is established is connected.

According to a third aspect of the invention, there is provided a network telephone system including: a telephone terminal and a gateway. The telephone terminal is connected to a first communication line for transmitting voice packets, converts the voice packets received through the first communication line into a voice signal, converts input voice signal into voice packets, and transmits the converted voice packets through the first communication line. The gateway is connected to the first communication line and to a second communication line for transmitting the voice signal, and selectively establishes connection between telephone terminals connected to the first communication line and between the telephone terminal and a terminal connected to the second communication terminal in accordance with a request for establishing the connection. The gateway includes a notification means for notifying to the telephone terminal of line identification information that identifies to which of the first and the second communication line the other end of the telephone terminal or the terminal which the connection is established is connected. The telephone terminal includes: a compensation means for compensating quality of a received voice signal with an arbitrary level of compensation; and a control means for controlling the level of compensation performed by the compensation unit in accordance with the line identification information notified by the notification unit.

### BRIEF DESCRIPTION OF THE DRAWINGS

In the accompanying drawings,

FIG. 1 is a schematic view showing the configuration of an exchange system according to a first embodiment of the present invention;

FIG. 2 is a block diagram showing the functional configuration of an IP telephone terminal in the first embodiment;

FIG. 3 is a view for explaining an operation example of a previously-conceived IP telephone terminal;

FIG. 4 is a view for explaining a quality compensation measure for a received voice signal in the previously-conceived IP telephone terminal; and

FIG. 5 is a schematic view showing the configuration of an exchange system according to a second embodiment of the present invention.

### DETAILED DESCRIPTION OF THE EMBODIMENTS

Hereinafter, embodiments of the invention will be described by reference to the drawings in detail.

### First Embodient

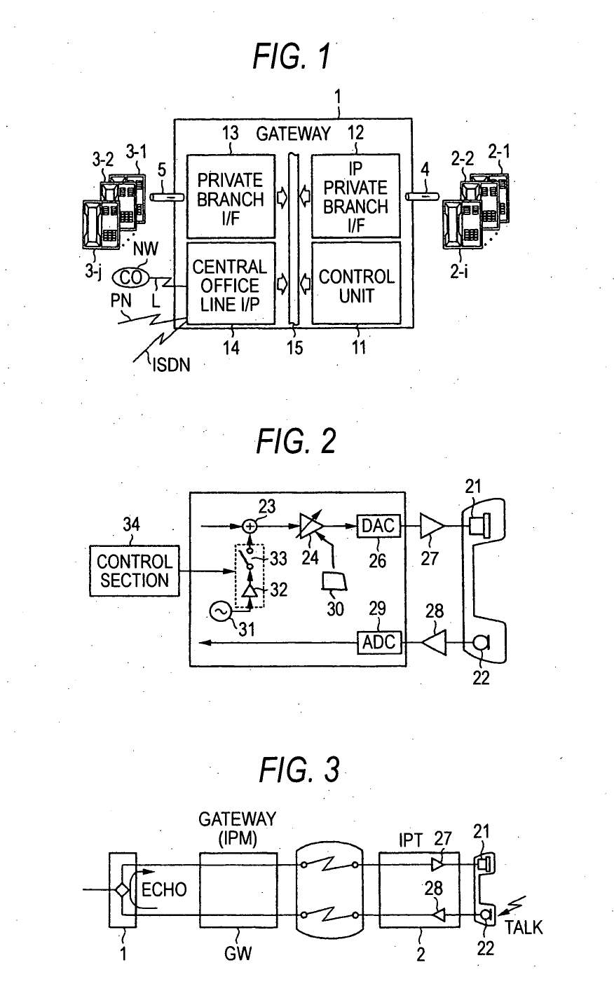

FIG. 1 is a schematic view showing the configuration of an exchange system according to a first embodiment of the present invention.

As shown in the drawing, the exchange system is configured such that each of a plurality of IP telephone terminals (2-1 to 2-i) is arbitrarily connected to a gateway (switching equipment) 1 by way of a LAN (local area network) 4; and each of a plurality of telephone terminals 3 (3-1 to 3-i) is arbitrarily connected by way of an analogue private branch 5.

The gateway 1 includes a control unit 11, an IP private branch interface circuit 12, a private branch interface circuit 13, and a central office line interface circuit 14. The control unit 11, the IP private branch interface circuit 12, the private branch interface circuit 13, and the central office line interface circuit 14 are connected to each other by way of a bus 15.

The control unit 11 arbitrarily performs switching connection among the IP private branch interface circuit 12, the private branch interface circuit 13, and the central office line interface circuit 14. When the IP telephone terminal 2-1 and the telephone terminal 3-1 are connected to each other, line type information reporting the private branch 5 to the IP telephone terminal 2-1 is transmitted as control information to the IP telephone terminal 2-1; and line type information indicating the LAN 4 associated with the telephone terminal 3 is transmitted as control information to the telephone terminal 3.

The IP telephone terminal 2 is connected to the IP private branch interface circuit 12 as required. The IP private branch interface circuit 12 performs a private branch interface operation with regard to the thus-connected IP telephone terminal 2. In addition, the IP private branch interface circuit 12 exchanges a variety of control information related to the private branch interface operation with the control unit 11 by way of the bus 15.

The telephone terminal 3 is connected to the private branch interface circuit 13 as required. The private branch interface circuit 13 performs a private branch interface operation with regard to the thus-connected telephone terminal 3. In addition, the private branch interface circuit 13 exchanges a variety of control information related to the private branch interface operation with the control unit 11 by way of the bus 15.

A central office line L connected to a public switched network NW, a private line PN, and an ISDN are connected to the central office line interface circuit 14 as required. The central office line interface circuit 14 performs an interface operation with regard to the thus-connected central office line L, the private line PN, and the ISDN. In addition, the central office line interface circuit 14 exchanges a variety of control information related to the interface operation with the control unit 11 by way of the bus 15.

FIG. 2 is a block diagram showing the functional configuration of the IP telephone terminal 2 according to the invention.

The IP telephone terminal 2 includes a speaker 21 and a microphone 22; and further includes, as a call-receiving system, a mixer 23, a amplifier 24, a D/A converter 26, and an amplifier 27. In addition, the IP telephone terminal 2 includes, as a call-transmission system, an amplifier 28, an A/D converter 29, and a volume control key 30.

During telephone conversation, the mixer 23 superimposes comfort noise on a received digital voice signal extracted from incoming IP packets, and the voice signal is converted to an appropriate volume level by the amplifier 24. Thereafter, the signal is converted into an analogue received voice signal by the D/A converter 26, and amplified by the amplifier 27. The thus-amplified received voice signal is sound-amplified by the speaker 21 and output therefrom.

The volume level of the amplifier 24 is controlled by the volume control key 30.

A transmission voice signal input by way of the microphone 22 is amplified in the amplifier 28, and converted into a digital transmission voice signal in the A/D converter 29. Thereafter, the voice signal is converted into voice packets and transmitted to the LAN 4.

Meanwhile, the comfort noise is generated by a noise generator 31, amplified to a noise level having been variably set by a comfort amplifier 32, and thereafter, supplied to the mixer 23 by way of a switch 33.

In addition, in the IP telephone terminal 2, line type information is supplied from the gateway 1 to a control section 34 during a telephone conversation. For instance, when the device of the other party is an IP telephone terminal connected to the LAN 4, the control section 34 switches off the switch 33 in accordance with the line type information. When the device is the telephone terminal 3 connected to the private branch 5, a center office line L, the private line PN, or ISDN, the control section 34 switches on the switch 33, and sets the level of noise applied to the comfort amplifier 32 to an value for appropriate for the private branch 5, the center office line L, the private line PN, or the ISDN.

Next, operation to be performed by the above configuration will be described.

As shown in FIG. 3, in relation to the above system, when a voice is originated from the microphone 22 of the IP telephone terminal 2 toward the other party of the line under connection by way of an analogue private branch 5, a 2-4 conversion circuit causes an echo (a sidetone) to arise in the private branch interface circuit 13.

When the IP telephone terminal 2 is connected to an analogue line to thus carry on a telephone conversation, a delay of tens of milliseconds arises in the communication effected by the LAN 4 interposes between the IP telephone terminal 2 and a gateway of the gateway 1. When the delay is heard as a sidetone at the speaker 21 of the IP telephone terminal 2, the sidetone includes a delay of about 100 milliseconds. This means that a participant in the conversation hears his/her own voice in a delayed manner, thereby seriously impairing conversation quality.

When a currently-used telephone is a single line telephone (SLT) or a digital key telephone (DKT), a voice spoken toward a handset returns substantially instantaneously (in less than 1 millisecond) as a sidetone. Accordingly, the user can carry on a telephone conversation without particular discomfort.

Also when the ISDN or the private line PN is used, or when the IP connects the telephone to another system, in some cases the conversation line is further connected to an analogue line. Accordingly, the same phenomenon as above sometimes occurs when a telephone conversation is held by way of the IP telephone terminal 2.

Furthermore, even in a private branch call, when the telephone connected to the other end of the line is a speakerphone, a sound originating from the speaker is picked up by a microphone. Accordingly, there are some occasions where a high-level echo sound is generated and the echo returns to the IP telephone terminal 2. In this case, the sidetone of the IP telephone is heard as a delayed voice, as well.

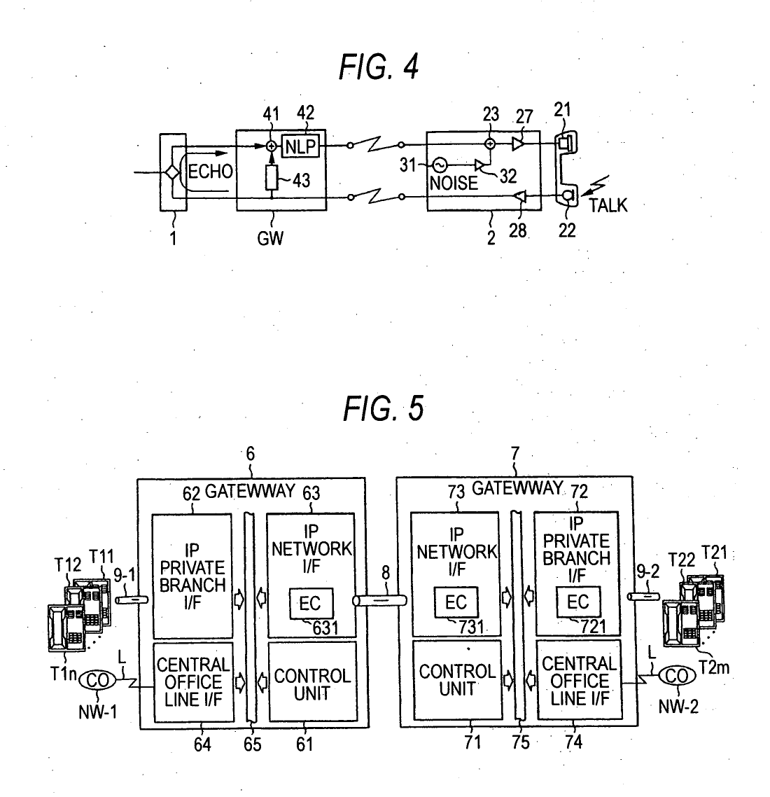

To this end, a business telephone system having an IP telephone connection function employs a method to dispose echo cancellers (41 and 43) on a line connected to the IP telephone terminals 2 and between telephone terminals, thereby lowering the sidetone, as shown in FIG. 4.

The echo canceller (41 and 43) is generally used in combination with a voice-loss circuit, which is called a non-linear processor (NLP) 42. The echo canceller has the function of estimating an incoming echo, thereby canceling the echo. However, since the echo canceller cannot cancel the echo completely, a cancellation-residual signal is generated.

The NLP 42 inserts, during a conversation in one direction, a loss to a conversation path of the other direction, thereby preventing the user from hearing a surplus residual signal which remains after cancellation by the echo canceller.

However, the NLP 42 has such a disadvantage that the NLP becomes a noise source, although noise generated by the NLP 42 is low. The NLP 42 causes a loss to arise in a conversation path, eliminates a loss, or varies a level of the loss adaptively. In a case where apparently one party speaks, a loss is continuously caused to arise in a voice path on the other side. However, when neither party speaks or when both parties speak simultaneously, losses are repeatedly caused to arise and eliminated at high speed, thereby ensuring availability of simultaneous conversation.

Depending on an environment where the IP telephone terminal 2 is placed, this high-speed switching operation of the loss is heard as unpleasant noise. For instance, in an environment with comparatively low ambient noise, such as noise originating from an air conditioner, the ambient noise repeatedly exceeds a threshold value for loss insertion by the NLP or falls lower than a threshold value for loss elimination. Therefore, the other party hears choppy noise, which is heard as an unpleasant, rustling noise, rather than continuous noise originating from the air conditioner.

When a parameter such as the threshold value is changed in an attempt to suppress this noise, the sense of simultaneous conversation is impaired. Noise generated by the NLP 42 is considerably low as compared with a normal conversation signal level. However, since the noise is heard at a silent portion between words, the noise is obtrusive.

Hence, in the first embodiment, comfort noise, which is low white noise, is mixed into a received voice signal in the IP telephone terminal 2, thereby rendering the NLP noise unobtrusive.

The comfort noise of a predetermined level is superimposed on the received voice signal. The noise masks intermittent noise originating from a line. The method enables reduction in the noise of the NLP to such a degree as not be recognized as being obtrusive.

Meanwhile, in relation to a full-digital telephone conversation, such as peer-to-peer, a telephone conversation of extremely high quality can be carried on without requiring an echo canceller (41 and 43) or a circuit, such as an NLP 42, on a conversation path, or without activation thereof even when they are provided. However, when comfort noise is superimposed, the quality is deteriorated conversely.

In addition, there also arises a problem that, since the comfort noise level is constant, in a case where a volume level is increased when the voice level of the other party of the telephone conversation is low, the comfort noise is also increased, thereby exhibiting loud grating noise.

To this end, depending on a line used for a telephone conversation, the gateway 1 transmits a code in accordance with a line type; that is, line type information, to the IP telephone terminal 2 by use of the control signal. When the other party of the telephone conversation is the IP telephone terminal 2-3, the IP telephone terminal 2-1 opens the switch 33 upon receipt of the code.

Meanwhile, a gain in the amplifier 24 differs from a case where a telephone conversation is held with the telephone terminal 3-1 on the private branch 5 and a case where the same is made with the central office line L. This gain switching is also performed by use of the previously-mentioned code. The control section 34 varies a level of noise generated by the comfort amplifier 32 in accordance with the code. As a result, comfort noise of a level appropriate to a conversation path can be provided to the speaker 21.

As an application thereof, even when a volume of a received voice is varied while connection to an analogue line is maintained, a volume level of the comfort noise is varied in accordance with a volume value of the received voice.

As described above, in the first embodiment, when, for instance, a telephone conversation is carried on by way of the IP telephone terminal 2-1, the control section 34 of the IP telephone terminal 2-1 adjusts the level of comfort noise through control of the comfort amplifier 32 so as to superimpose the comfort noise on a received voice signal in accordance with the private branch 5 to which the telephone terminal 3 on the other end of the line is connected.

Accordingly, optimum compensation for each of the communication lines, to which the telephone terminal is connected, is enabled. That is, when the other party of the telephone conversation is the IP telephone terminal 2-3, the switch 33 is turned off, thereby preventing the comfort noise from being superimposed on the received voice signal; and when the other party of the telephone conversation is the private branch 5, the central office line L, the private line PN, or the ISDN, comfort noise is superimposed on a received voice signal. As a result, advancement in conversation quality, which has not been attained by conventional systems, can be achieved.

In addition, in the first embodiment, optimum compensation of received voice signal quality is enabled even when a user of the IP telephone terminal 2 adjusts the volume to his or her preferred level. As a result, the user of the IP telephone terminal 2 can have a favorable telephone conversation under any usage situation.

### Second Embodiment

FIG. 5 is a schematic view showing the configuration of an exchange system according to a second embodiment of the present invention.

As shown in the drawing, the exchange system includes gateways 6, 7, which are connected by way of a LAN 8. The gateway 6 arbitrarily connects each of a plurality of IP telephone terminals T1 (T11 to T1n) by way of a LAN 9-1. The gateway 7 arbitrarily connects each of a plurality of IP telephone terminals T2 (T21 to T2m) by way of a LAN 9-2.

The gateway 6 further includes a control unit 61, an IP private branch interface circuit 62, an IP network interface circuit 63, and a central office line interface circuit 64. The control unit 61, the IP private branch interface circuit 62, the IP network interface circuit 63, and the central office line interface circuit 64 are connected to each other by way of a bus 65.

The control unit 61 arbitrarily performs switching connection among the IP private branch interface circuit 62, the IP network interface circuit 63, and the central office line interface circuit 64. In addition, the control unit 61 notifies the other party of the telephone conversation of line type information.

The LAN 8 is connected to the IP network interface circuit 63 as required. The IP network interface circuit 63 performs a private branch interface operation with regard to the thus-connected LAN 8. In addition, by way of the bus 65, the IP network interface circuit 63 exchanges with the control unit 61 a variety of control information related to the private branch interface operation.

A central office line L connected to a public switched network NW-1 is connected to the central office line interface circuit 64 as required. The central office line interface circuit 64 performs an interface operation with regard to the thus-connected central office line L. In addition, by way of the bus 65 the central office line interface circuit 64 exchanges with the control unit 61 a variety of control information related to the interface operation.

Incidentally, an echo canceller 631 for canceling an echo added to a voice signal is provided in the IP network interface circuit 63.

Meanwhile, the gateway 7 includes a control unit 71, an IP private branch interface circuit 72, an IP network interface circuit 73, and a central office line interface circuit 74. The control unit 71, the IP private branch interface circuit 72, the IP network interface circuit 73, and the central office line interface circuit 74 are connected to each other by way of a bus 75.

The control unit 71 arbitrarily performs switching connection among the IP private branch interface circuit 72, the IP network interface circuit 73, and the central office line interface circuit 74.

Meanwhile, an echo canceller 721 for canceling an echo added to a voice signal is provided in the IP private branch interface circuit 72, and an echo canceller 731 is provided in the IP network interface circuit 72.

The IP telephone terminals T11 to T1n and T21 to T2m have the same functions as the IP telephone terminals 2-1 to 2-i; therefore, detailed explanations thereof are omitted.

Next, operations in the above configuration will be described.

For instance, assume that, in the IP telephone in a public switched network NW-2 is made, and that, in response thereto, a termination call from a LAN 9-1 has arrived at the gateway 6. The termination call is detected in the IP private branch interface circuit 62, and the control unit 61 is notified thereof by way of the bus 65.

The control unit 61 analyzes a dial number of a destination from the thus-notified termination call, and from a result of this analysis makes a determination as to whether or not the destination is the gateway 7. When the destination is determined to be the gateway 7, the control section 61 notifies the IP telephone terminal T11 of line type information indicating the public switched network NW-2, and of cancellation level information indicating respective levels of cancellation performed by the echo cancellers 631 and 731.

In response, in accordance with the line type information and the cancellation level information the IP telephone terminal T11 adjusts the level of comfort noise to be superimposed on a received voice signal.

As described above, according to the second embodiment, in a case where a telephone conversation is carried on by way of the IP telephone terminal T11, when the echo cancellers 631 and 731 are connected, the level of comfort noise is controlled so as to be superimposed on a received voice signal in accordance with levels of cancellation by the echo cancellers 631 and 731. Therefore, even when the echo cancellers are connected, optimum compensation of received voice signal quality is enabled.

### Other Embodiments

Meanwhile, the invention is not limited to the above embodiments. For instance, the embodiments have been described by reference to examples in which comfort noise is superimposed on a received voice signal. However, the invention is not limited thereto, and other items other than the comfort noise for performing quality compensation of a received voice signal may be employed.

The second embodiment has been described by reference to an example where a connection is established between two gateways. However, a connection may be established among a number of; that is, at least two gateways.

Also with regard to the configuration and a type of the system, the configuration and a type of the gateway, the configuration of an IP telephone terminal, a compensation procedure of a received voice signal, and the like, the invention can be modified and practiced in various manners without departing from the scope thereof.

In the above-described embodiments, the control units 11, 61, and 71 serves as a notification unit that notifies to the telephone terminal of the line identification information that identifies to which of the first and the second communication line the other end of the telephone terminal or the terminal which the connection is established is connected.

In the embodiment, the mixer 23, the noise generator 31, the comfort amplifier 32, and the switch 33 serve as a compensation unit that compensates quality of a received voice signal with an arbitrary level of compensation. The control section 34 serves as a controller that controls the level of compensation performed by the compensation unit in accordance with the line identification information notified by the notification unit.

As described with reference to the embodiments, according to the network telephone system, a telephone terminal is given the function of controlling, when a telephone conversation is carried on by way of the telephone terminal, a level of compensation performed on a received voice signal in accordance with a communication line to which a telephone terminal of the other party of the telephone conversation is connected. Accordingly, an optimum compensation for each communication line to which the telephone terminal is connected is enabled. Specifically, compensation is not effected on the received voice signal quality when the first communication lines where low noise is superimposed on voice signals are connected; and compensation is performed on the received voice signal quality when the telephone terminal is connected to the second communication line.

According to the network telephone system, in a case where the echo canceller is connected when of telephone conversation is carried on by way of the telephone terminal, the level of noise is controlled so as to be superimposed on a received voice signal in accordance with the level of cancellation by the echo canceller. Therefore, even when the echo canceller is connected, optimum compensation of the received voice signal is enabled.

According to the network telephone system, optimum compensation of the received voice signal is enabled even when the user of the telephone terminal has controlled a volume to his or her preferred level. As a result, the user of the telephone terminal can carry on a favorable telephone conversation under any usage situation.

As has been described in detail, there is provided a network telephone system which can favorably maintain the quality of a received voice signal at a telephone terminal even when different communication lines are connected, as well as when an echo canceller being connected; and a telephone terminal to be used in the network telephone system.

The invention is not absolutely limited to the embodiment. In an execution phase, constituent parts can be modified to give a shape to the invention without departing the scope and sprit thereof. In addition, various inventions can be formed by suitable combinations of a plurality of constituent parts disclosed in the aforementioned embodiment. For example, some constituent parts may be deleted from the whole constituent parts disclosed in the embodiment. Further, constituent parts in different embodiments may be combined suitably.

What is claimed is:

1. A network telephone system comprising:
a telephone terminal that is connected to a first communication line for transmitting voice packets, converts the voice packets received through the first communication line into a voice signal, converts input voice signal into voice packets, and transmits the converted voice packets through the first communication line; and
a gateway that is connected to the first communication line and to a second communication line for transmitting the voice signal, and selectively establishes connection between telephone terminals connected to the first communication line and between the telephone terminal and a terminal connected to the second communication terminal in accordance with a request for establishing the connection,
wherein the gateway includes a notification unit that notifies to the telephone terminal of line identification information that identifies to which of the first and the second communication line the other end of the telephone terminal or the terminal which the connection is established is connected, and
wherein the telephone terminal includes:
a compensation unit that compensates quality of a received voice signal with an arbitrary level of compensation; and
a controller that controls the level of compensation performed by the compensation unit in accordance with the line identification information notified by the notification unit.

2. The network telephone system according to claim 1, wherein the compensation unit superimposes a noise signal on the received voice signal, and
wherein the controller controls a level of the noise signal to be superimposed by the compensation unit in accordance with the line identification information notified by the notification unit.

3. The network telephone system according to claim 2, wherein when the telephone terminal is connected to an echo canceller that cancels an echo added to the voice signal, the notification unit appends cancellation level information to the line identification information, the cancellation level information indicating cancellation level of the echo canceller, and
wherein the controller controls the level of the noise signal in accordance with the cancellation level information.

4. The network telephone system according to claim 2, wherein the telephone terminal further includes a volume control key that controls output volume of the voice signal converted from the voice packets, and
wherein the controller controls the level of the noise signal in accordance with the output volume of the voice signal.

5. A telephone terminal that is connected to a first communication line for transmitting voice packets, converts the voice packets received through the first communication line into a voice signal, converts input voice signal into voice packets, and transmits the converted voice packets through the first communication line, the telephone terminal comprising:
a compensation unit that compensates quality of a received voice signal with an arbitrary level of compensation; and
a controller that controls the level of compensation performed by the compensation unit in accordance with line identification information notified by a gateway that is connected to the first communication line and to a second communication line for transmitting the voice signal, the gateway selectively establishing connection between telephone terminals connected to the first communication line and between the telephone terminal and a terminal connected to the second communication terminal in accordance with a request for establishing the connection, the line identification information identifying to which of the first and the second communication line the other end of the telephone terminal or the terminal which the connection is established is connected.

6. The telephone terminal according to claim 5, wherein the compensation unit superimposes a noise signal on the received voice signal, and
wherein the controller controls a level of the noise signal to be superimposed by the compensation unit in accordance with the line identification information notified by the gateway.

7. The telephone terminal according to claim 6, wherein when the telephone terminal is connected to an echo canceller that cancels an echo added to the voice signal, the controller controls the level of the noise signal in accordance with cancellation level information appended to the line identification information by the gateway, the cancellation level information indicating cancellation level of the echo canceller.

8. The telephone terminal according to claim 6 further comprising a volume control key that controls output volume of the voice signal converted from the voice packets,
wherein the controller controls the level of the noise signal in accordance with the output volume of the voice signal.

9. A network telephone system comprising:
a telephone terminal that is connected to a first communication line for transmitting voice packets, converts the voice packets received through the first communication line into a voice signal, converts input voice signal into voice packets, and transmits the converted voice packets through the first communication line; and
a gateway that is connected to the first communication line and to a second communication line for transmitting the voice signal, and selectively establishes connection between telephone terminals connected to the first communication line and between the telephone terminal and a terminal connected to the second communication terminal in accordance with a request for establishing the connection,
wherein the gateway includes a notification means for notifying to the telephone terminal of line identification information that identifies to which of the first and the second communication line the other end of the telephone terminal or the terminal which the connection is established is connected, and
wherein the telephone terminal includes:
a compensation means for compensating quality of a received voice signal with an arbitrary level of compensation; and
a control means for controlling the level of compensation performed by the compensation unit in accordance with the line identification information notified by the notification unit.
